(19) United States
(12) Patent Application Publication
(10) Pub. No.: US 2006/0255019 A1
(43) Pub. Date: Nov. 16, 2006

(54) Apparatus and methods for conducting laser stir welding

(76) Inventors: Richard P. Martukanitz, State College, PA (US); Jay F. Tressler, Bellefonte, PA (US)

Correspondence Address: Martin S. Bancroft;Gifford, Krass, Groh, Sprinkle,, Anderson & Citkowski, P.C., PO Box 7021, Troy, MI, 48007-7021, US

(21) Appl. No.: 11/413,078

(22) Filed: Apr. 28, 2006

Related U.S. Application Data
(63) Continuation-in-part of application No. 10/821,734, filed on Apr. 8, 2004.
Application No. 10/821,734 is a continuation-in-part of application No. 10/155,688, filed on May 24, 2002, now Pat. No. 6,740,845.
(60) Provisional application No. 60/675,607, filed on Apr. 28, 2005.

(51) Int. Cl. B23K 26/26

(52) U.S. Cl. 219/121.64; 219/121.63

(57) ABSTRACT

A method of welding metal components together including moving a laser beam in a first direction along an interface between a pair of metal components such that in the vicinity of the focused beam, metal from each component is vaporized to produce a keyhole in a pool of molten metal. The laser beam is oscillated in a direction different from (e.g., transverse to) the first direction such that the keyhole oscillates through the pool of molten metal and molten metal fills into the keyhole as the position of the keyhole changes. A laser welding apparatus achieves oscillation of the laser beam using optical elements in the path of the laser beam, for example trepanning optics located within an expanded portion of the laser beam.

### REFERENCE TO RELATED APPLICATIONS

This application is a continuation-in-part of U.S. patent application Ser. No. 10/821,734, filed Apr. 8, 2004, which is a continuation-in-part of U.S. patent application Ser. No. 10/155,688, filed May 24, 2002, now U.S. Pat. No. 6,740,845, and claims priority from U.S. Prov. App. 60/675,607, filed Apr. 28, 2005, the contents of both of which are incorporated by reference.

### FIELD OF THE INVENTION

The present invention relates to laser welding, and more particularly, laser welding with an oscillating laser beam.

### BACKGROUND OF THE INVENTION

Common welded joints include butt joints, lap-penetration joints, and lap-fillet joints. Laser welding is a method of joining metal components using a focused beam of coherent light to melt adjoining components and allowing the melt to solidify into a joint. While butt joints may be produced by laser welding, they are not always suitable in the aerospace, automotive, and marine industries. Laser welding of lap-penetration joints and lap-fillet joints is more difficult to accomplish.

FIGS. 1 and 2 depict the weld region during laser beam welding of a lap-penetration joint in which a laser beam is directed at the region of an interface 2 between components 4 and 6. Relative movement is effected along the interface 2 between the laser beam and the assembly of components. The laser beam may cause a portion of metal in the weld region to volatilize to produce a keyhole 8 bounded by molten metal 10. The keyhole 8 advances with the movement of the laser beam in the direction of the arrow A. Molten metal 10 solidifies behind the advancing keyhole 8 to create a joint between the components.

In practice, production of lap-penetration joints and lap-fillet joints via laser welding is limited. For example, in a lap-penetration joint as shown in FIGS. 1 and 2, it is well established that the width W of the weld at the interface 2 should be equal to or exceed the thickness t of the thinnest of the components being joined. The welding process must be controlled to minimize formation of voids in the welds that are caused by instabilities in the keyhole and/or volatilization of low melting constituents with high partial pressures (e.g., Mg). In addition, laser welding is relatively costly. The laser beam is generally operated at or above 10⁶ W/cm²; efficiency dictates a need to weld at rates of at least 80 inches per minute (ipm) at this power level. With welding components up to 0.1 inch thick, it is possible to produce the required 0.1 inch weld width W at speeds exceeding 120 ipm. The formation of voids can be adequately controlled by use of defocused beams or bifocal optical systems. However, with thicker materials it is progressively more difficult to achieve the required weld width while still maintaining acceptable weld quality and speeds of travel.

With laser welding lap-fillet joints, the welding system must accommodate variations in lateral placement of the laser beam relative to the joint edge and gaps between the components to attain performance comparable to deposits made with gas metal arc welding (GMAW) at rates that justify using costlier laser welding systems.

One option for overcoming the challenges in laser welding lap-penetration and lap-fillet joints is to use beam integrators, focusing optics (mirrors or lenses) with longer focal length or defocused beams. However, to ensure reliable and consistent optical coupling between the laser and components to be joined and to achieve localized melting at the joint, the power output of the laser system must be increased to compensate for the reduction in power density. With sufficient power output, widened welds can be produced in the more placid conduction mode rather than the keyhole mode. Unlike the latter mode, which involves translation of a cavity (or keyhole) along the joining area, the conduction mode is achieved by translating a molten pool of metal along the joining area. By minimizing the violent volatilization of metal within the keyhole, the more placid conduction mode can eliminate the instabilities inherent with the keyhole mode. As a result, the conduction mode minimizes the formation of voids in the laser welds. However, implementing this approach necessitates using very powerful lasers (e.g., 18 kW to 25 kW, depending on the application) and costly laser generating systems, which makes the approach impractical for many industrial applications.

Another approach to increasing the effectiveness of laser welding is described in U.S. Pat. No. 4,369,348 by oscillating the laser beam at frequencies of over 1000 Hz. This very rapid movement of the laser is intended to distribute and time average the intensity of the laser at a frequency greater than the thermal response time of the metal. In this manner, the time averaged intensity of heat experienced by a particular location at the interface between the metal components being joined is greater than the intensity of heat experienced without oscillation. However, operation of a laser beam at oscillation frequencies of over 1000 Hz is difficult and costly. In addition, the only way to implement this approach is to weld in the conduction mode where a continuous molten pool is maintained. Accordingly, a need remains for a low cost, effective method of laser welding.

### BRIEF DESCRIPTION OF THE DRAWINGS

FIG. 1 is a schematic cross-sectional view of a pair of metal components laser welded to form a keyhole according to the prior art;

FIG. 2 is a top view of the stack of-components shown in FIG. 1 operated according to the prior art;

FIG. 3 is a perspective view of a pair of metal components laser welded according to the method of the present invention;

FIG. 4 is a top view of the stack of components shown in FIG. 3;

FIG. 5 is a schematic cross-sectional view of the metal components shown in FIG. 4 taken along line 5-5; and

FIG. 6 is a schematic of a trepanning module which can be used in examples of the present invention.

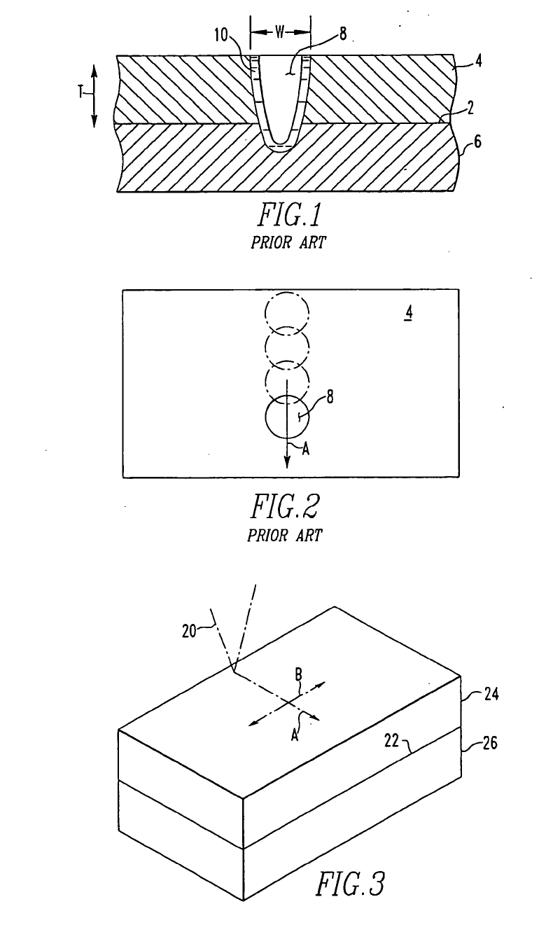

### SUMMARY OF THE INVENTION

A method of laser welding a pair of metal components together along a metal interface comprises providing laser radiation, passing the laser radiation through a beam conditioner, and converging the laser radiation to a focus point proximate to the metal interface. In preferred examples of the present invention, the beam conditioner comprises rotational optics, the rotational optics including one or more optical elements configured induce oscillatory motion of the focus point of the laser radiation. The laser radiation at the focus point has an optical intensity such that in the vicinity of the focus point, metal from each of the pair of metal component melts and vaporizes to produce a keyhole in a pool of molten metal. The oscillatory motion of the focus point may include a substantially circular motion, a substantially elliptical motion, a spiral motion, linear motion, or some combination thereof.

In some examples of the present invention, a method comprises expanding an initial laser beam to provide an expanded laser beam, conditioning the expanded laser beam, and focusing the expanded laser beam to a focus point proximate to a metal interface. The conditioning of the expanded laser beam induces an oscillatory motion of the focus point, such as a circular motion. The conditioning may include moving (such as rotating) one or more optical elements within the expanded laser beam. The optical element may be a prism (such as a wedge prism), a lens, other refractive component, a reflective component such as a mirror, or a diffractive component. The beam conditioner may comprise some combination of optical elements. In a preferred embodiment, a pair of wedge prisms are rotated within the expanded laser beam. The method may further comprise translating the focus point along a direction substantially parallel to the metal interface, so as to form a weld along the interface. The initial laser beam may be received through an optical fiber. The method may further include collimating the expanded laser beam, for example using a collimating lens, and rotating at least one optical element within a substantially parallel expanded beam.

Apparatus and methods according to the present invention can be used to form various weld types, such as a lap-penetration weld, a butt weld, or a lap-fillet weld. The welds can be formed between aluminum alloys, or other metals. In representative examples of the present invention, the focus point oscillates at a frequency between approximately 5 Hz and approximately 120 Hz, the focus point moves along the interface at a rate of about 5 to about 400 inches per minute, and the laser weld has a width between about 0.1 inch and about 0.25 inch. One of the pair of metal components may thinner than the other of the pair of metal components, said thinner component being over about 0.1 inch thick.

In examples of hybrid laser welding according to embodiments of the present invention, an arc welding torch along the direction substantially parallel to the metal interface. For example, the arc welding torch may be configured to move either ahead or behind the focus point. Molten metal from may be discharged from an arc welding torch into a pool of molten metal formed proximate to the focus point, and the arc welding torch may be, for example, a GMA welding torch or a plasma welding torch.

### DETAILED DESCRIPTION OF THE INVENTION

In apparatus and methods according to examples of the present invention, components (such as steel, aluminum alloys or titanium alloys) are laser welded together. A method of welding components together comprises moving a laser focus point along a first direction along an interface between the components, and oscillating the focus point through a direction different from the first direction. In a preferred embodiment, the oscillation of the focus point includes a generally circular or elliptical motion. In some embodiments of the present invention, the oscillation of the focus point is introduced using a beam conditioner including at least one rotating optical element. The oscillatory motion preferably includes a component perpendicular to the interface of the components to be welded.

FIG. 3 shows radiation 20 (such as a laser or plasma beam) focused in a round spot (at the focus point) over an interface 22 between a pair of metal components 24 and 26. The metal components 24 and 26 are stacked upon one another to form a lap-penetration weld. This is not meant to be limiting; other weld joints may be produced according to a method of the present invention, such as butt welds and lap-fillet welds. The laser beam 20 travels in the direction of arrow A, which may follow a linear path or a path of another configuration. The path of arrow A determines the location of the joint between the components 24 and 26.

While the laser beam 20 travels in the direction of arrow A, the laser beam 20 also is oscillated in the direction of double arrow B. Double arrow B is at an angle to arrow A such as transverse to the direction of arrow A. In FIG. 3, the laser beam 20 is shown as oscillating in a linear path perpendicular to arrow A, but this is not meant to be limiting. The laser beam 20 may travel in other paths, such as circular, elliptical, sinusoidal, or the like.

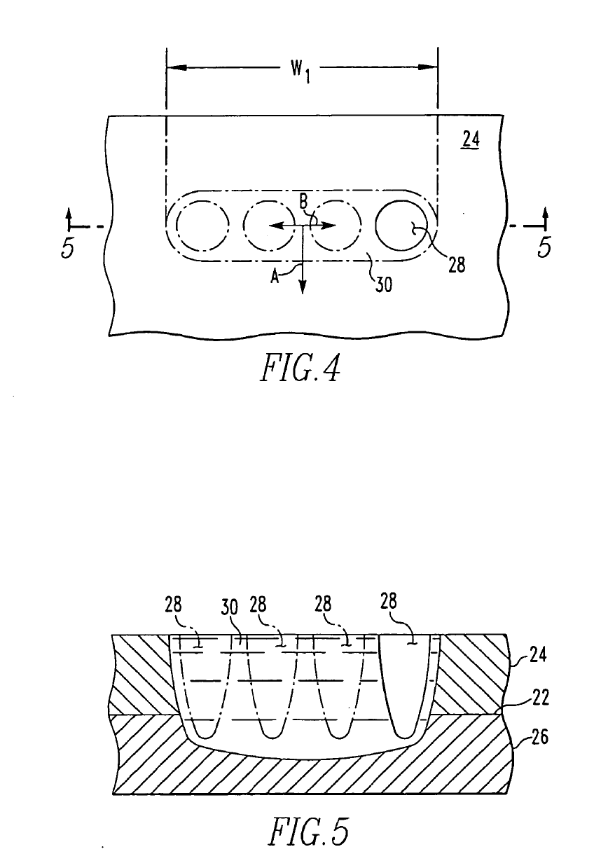

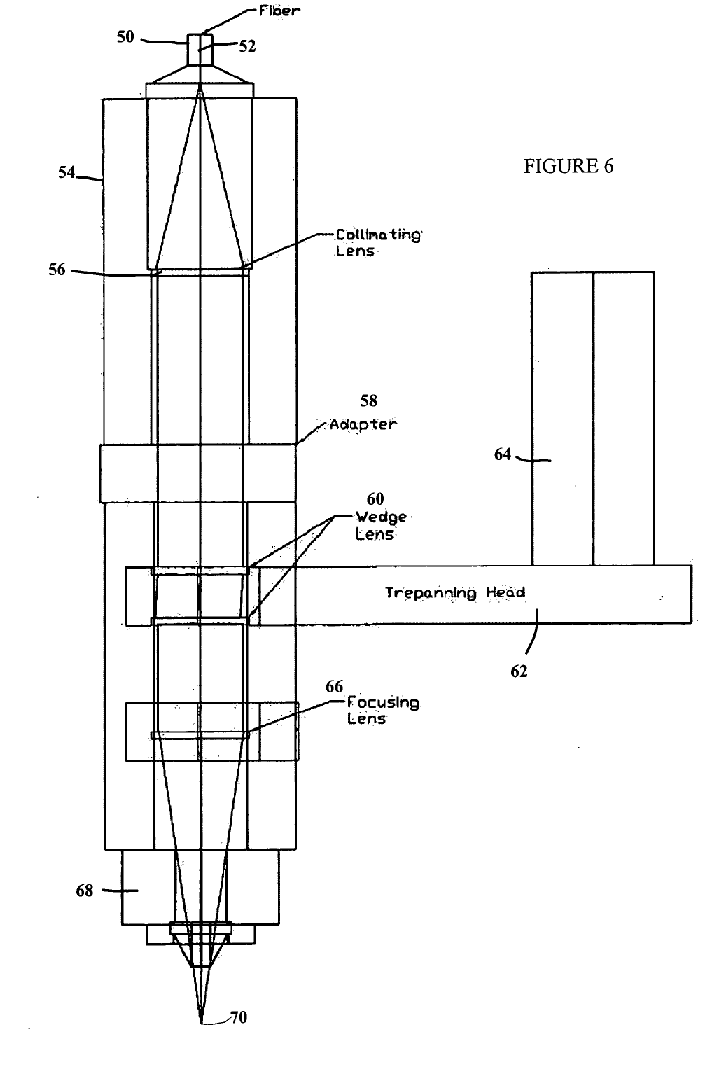

In the vicinity of the focused laser beam 20, as shown in FIGS. 4-5, the metal of the components 24 and 26 melts and vaporizes (as shown by the outline of vaporized metal at 27 in FIG. 6) to produce a keyhole 28 surrounded by molten metal 30. Metal vapors 27 from the molten metal 30, which is a mixture of components 24 and 26, escape from the keyhole 28 and produces a plume or plasma above the surface of the upper component 24.

The focal point of the laser beam 20 is shown schematically at 25 in FIG. 5 and FIG. 6 and is generally well below the upper surface of the upper component 24. Oscillation of the laser beam 20 causes the keyhole 28 to fill in with molten metal 30 and reform as a new keyhole 28 adjacent thereto. As the keyhole 28 continuously moves from one position to another position across the path of the arrow A and vacates its previous position in the pool of molten metal 30, the vacated keyhole 28 fills in and reforms as a new keyhole 28. This process has the appearance of movement of the keyhole transversely through the molten metal 30 with the molten metal 30 acting to continuously “heal” the vacated keyhole 28. In this manner, a weld having an interfacial width W is produced that is significantly wider than the welds attainable using the prior art welding techniques. For example, when welding lap-penetration joints, the implementation of the invention affords joining with welds having an interfacial width equal to or wider than the thickness of the thinner part being welded. Welds produced using this method are typically two to five times the width of laser beam welds produced using conventional methods. Wider welds are particularly helpful in producing lap-penetration welds in thicker components, i.e., components thicker than 0.1 inch and up to about 0.25 inch thick and for achieving complete fusion at the faying edge when the structure requires the lower component to be perpendicular to the upper component.

Suitable frequencies of oscillation of the laser beam 20 are about 5 to about 120 Hz, such as 10 Hz-50 Hz, and may be about 10 Hz. The laser beam may advance along the interface at a rate of about 5 to about 400 ipm, or about 40 to about 200 ipm, or about 80 ipm. Preferably, the laser spot is round, i.e. the laser radiation has a substantially circular cross-section at the focus point. The laser radiation power density at the focus point is preferably sufficient to maintain keyhole stability (for keyhole welding applications), so that a self-healing keyhole is obtained during oscillation of the focus point. For an aluminum alloy, an example power density is at least 10 kW/cm².

In certain instances, it may be helpful to include a source of filler material, such as a filler wire. Filler material may be added during welding and may be in the form of a wire, having a diameter of about between 0.030 and 0.062 inch, or a powder. The filler material may be an alloy selected based on the desired attributes of the weld using established engineering principles. The filler material may be added to the front or rear of the molten pool, typically, at an angle of between 15 and 60 degrees off of horizontal, i.e., the plane of the upper component. Processing gas may also be utilized to shield the molten pool and to redirect the vaporized metal away from the beam and material interaction zone, which is commonly referred to as plasma suppression. The gas typically is provided at the front or side of the weld pool through a nozzle directed to the rear or side, respectively, of the pool at an angle of between 30 and 60 degrees off of the horizontal.

Example of Oscillatory Motion

A lap-penetration laser weld was produced between a pair of 0.196 inch thick Alclad alloy 6013-T6 plates with 0.045 inch diameter alloy 4047 filler wire at 35° feed angle, 90 ipm wire feed rate using 10 KW power CO₂ laser (110 cfh flow rate of helium as plasma suppressing gas applied from the moving front) traveling at 80 ipm focused 0.25 inch below the top surface of the plate stack up. The laser was linearly oscillated in a direction transverse to the welding direction at 400 ipm, 0.25 inch total oscillation width (i.e., 0.125 inch center to center). The resultant interfacial weld width was slightly greater than 0.22 inch.

Laser stir welding of aluminum alloy components (AA 6013) was performed using a circle diameter of 2 mm to 4 mm, rotational speeds of 1000 to 3000 rpm (about 16.6 to 50 Hz), and travel speeds of 1-2 m/minute (about 40-80 inches/minute). A 4.5 kW Nd:YAG laser was used as the laser radiation source. Butt welds, lap welds, and fillet welds were achieved. A weld width of over 7 mm (0.28 in) and a weld penetration of over 5 mm (0.2 in) were achieved using a weld velocity of 1 m/min and a rotation speed of 3000 rpm.

Hybrid Welding

Another embodiment of the invention is laser-based hybrid welding. The phrase “laser-based hybrid welding” is meant to include welding processes that include a second welding process (e.g., GMAW or plasma welding) in addition to laser welding. In this embodiment, a second welding process (such as arc welding) is combined with the above-described laser welding with a self-healing keyhole.

A GMA (gas metal arc) or MIG (metal inert gas) welding process can be employed in combination with the above-described laser welding with self-healing keyhole. Other suitable arc welding processes may be used such as plasma welding. A MIG welder is positioned behind the laser beam in the direction of travel. Alternatively, the arc welder may be positioned in advance of the laser beam.

A MIG welder generally includes a torch with a continuously fed consumable welding wire. An electric arc between the tip of the wire and the molten pool continuously melts the wire. Inert processing gas passing through the torch supports the arc and shields the molten metal from oxidation. The longitudinal axis of the welding wire forms an angle a with vertical axis of the laser beam. Angle a may be about 10-50 degrees, preferably about 30 degrees. The size and shape of the pool of molten metal may vary, for example where the MIG welder follows the laser beam, a deeper pool of molten metalforms than if the MIG welder advances in front of the laser beam.

There are several advantages of combining MIG welding with laser beam welding with beam oscillation to induce a self-healing keyhole. The deposition rate of the welding wire from the MIG welder is higher when combined with laser welding. A greater volume of molten metal is produced in which the self-healing keyhole can be established and oscillated. With more base material and more welding wire melted per unit length of the weld than in either of the laser welding with a self-healing keyhole or MIG welding alone, welding speed can be increased. The larger volume of molten metal provides a larger volume of metal to fill the self-healing keyhole, which in turn enables the keyhole to heal. In addition, the keyhole heals more readily and uniformly. In addition, due to the inherent characteristics described above, the combination of beam oscillation with MIG welding provides a wider width of penetration at the weld root which is advantageous for enabling adequate penetration of the side walls when producing butt welds.

Trepanning Module

An improved laser welding apparatus includes trepanning optics, for example including one or more rotating optical elements that induce a circular motion of the focus point. Trepanning optics can be used to condition a high power laser beam, such as a 6 kW Nd:YAG laser beam, to allow laser welding with beam oscillation. The laser radiation can be expanded, for example to between approximately 2-100 times the original beam diameter, and the expanded beam conditioned using trepanning optics to give circular motion of a focus point derived from the expanded beam.

The term trepanning, in this specification, is used to describe generation of circular, spiral, elliptical, or other curved or linear oscillatory trajectories of the focus point by manipulation of the laser beam. In representative examples, the laser beam is expanded, and the expanded laser beam is conditioned using trepanning optics to induce circular motion of the focus point. However the term trepanning should not be limited to circular motion.

FIG. 6 shows a trepanning module having fiber 50 bringing the laser beam 52 to the housing 54 of the trepanning module. The laser radiation expands from the end of the fiber. Expanding the laser beam may further comprise passing the laser beam through a lens, such as a diverging lens. A collimating lens 56 provides an expanded and collimated (generally parallel) laser beam that passes through adapter 58 and spaced apart wedge elements at 60. A focusing lens (converging lens) 66 focuses the laser beam to a high intensity focus point at 70, the laser radiation intensity at the focus point capable of melting materials to be welded. The trepanning head 62, extending from drive unit 64, induces motion, in this example rotational motion, of the wedge elements so as to generate circular motion of the focus point 70 derived from the expanded laser beam.

The focus point can be, for example, a portion of a beam waist, or other narrowed portion of the laser beam. The wedge elements may be wedge prisms or wedge lenses. Wedge prisms are further described in U.S. Pat. No. 4,822,974 to Leighton, incorporated herein by reference. The trepanning module illustrated may included in a modified focus head for fiber optic delivery of laser radiation to the weld area. The trepanning module may move in relation to the materials to be welded, for example to superimpose a linear motion of the focus point along a metal interface onto an oscillatory motion obtained from the rotating optical elements. Alternatively, further optical elements within the trepanning head, such as a refractive element or a mirror, can be used to provide a linear motion, or the angle of the axis of the trepanning head to the surface can be changed so as to sweep the focus point across the surface.

The optical elements used for conditioning of the expanded laser beam may comprise one or more rotating optical elements. Optical elements may include one or more wedge elements (such as wedge prisms), mirrors, diffractive optics, rotating shaped disks, and the like. Motion of the optical elements may include rotational motion, motion along or about one or more axes, side-to-side tilting, distortion or the optical element, and the like. The beam conditioner, such as a trepanning head, may also include electrooptical elements such as electrooptical crystals, liquid crystals, spatial light modulators, active holograms, and the like, electrically controllable to impart an oscillatory motion on the focus point.

In a representative example, the trepanning optics include a pair of spaced apart wedge prisms, located sequentially along the laser beam. The wedge prisms rotate around the axis of the laser beam. A portion of each wedge prism may be mechanically coupled to a drive mechanism which may include such as a rotating shaft, for example an electric motor. The wedge prism may be housed in a rotating housing, allowing rotation about a rotation axis that is also the optical axis of the trepanning module. In other examples, the trepanning optics may also or alternatively comprise reflective or diffractive optics.

In a representative example, a trepanning module induces a circular motion of a focused laser beam spot (the focus point) proximate to a sample to be welded or otherwise laser treated. The circular motion can be combined with a linear motion along a weld seam, as described above, to provide a motion of the focus point that is oscillatory and generally tracks the length of the desired weld seam. In other examples, the focus point may follow a spiral, elliptical, or other curved path. The apparatus may further comprise a beam translator to induce the linear motion of the beam along an interface, such as a swivelling mirror, or a drive mechanism to move the beam conditioner along a linear path.

In the case of IR laser beams, the optical elements, including trepanning components, of the trepanning module comprise suitable IR transmissive materials, such as ZnSe. Optical fibers are readily available for transmission of Nd:YAG laser radiation (wavelength 1.06 microns, or frequency doubled at 530 nm). In the case of CO₂ laser radiation at 10.6 microns, advanced fiber materials are necessary. However, fiber delivery of the laser beam need not be used. Laser radiation may be delivered through free space, for example using a hard optic delivery system, or through an air or vacuum filled tube or other cavity, expanded using appropriate optics, conditioned using trepanning optics, and subsequently focused to a focus point on or near the weld area.

Multi-kW fiber-delivered lasers, which may be used with embodiments of the present invention, include diode-pumped Nd:YAG rod and disk lasers, and ytterbium-doped fiber lasers. Laser welding of aluminum is preferably achieved using laser radiation powers of 1 kW or greater.

In other examples, the laser beam is passed through a diverging lens on entering the trepanning module, or diverges from a fiber without needing a separate diverging lens, and is subsequently incident on the trepanning optics (such as a rotating optical element), the trepanning optics also collimating or converging the laser beam. A collimated beam can then be focused to a focus point using focusing optics. In other examples, the trepanning optics may also function as the focusing optics. The trepanning module may also allow delivery of a shielding gas or assist gas to the welding area.

An example laser welding apparatus includes a source of laser radiation (such as a laser, fiber carrying laser radiation, and the like), a beam expander, and a beam conditioner that conditions the expanded laser beam so that a focus point derived from the expanded beam describes a motion within a plane substantially parallel to a surface. The motion may be oscillatory, a term that as used here can include back-and-forth motion (linear or curvilinear), circular, elliptical, inward spiral, outward spiral, other periodic motion, or other motion having a component transverse to a weld seam or other direction of motion across a surface superimposed on the oscillatory motion. The oscillatory motion can be superimposed on a linear motion along an interface between a pair of metals (the weld seam), so that the resultant motion of the focus point (a combination of the oscillatory and linear motions) need not describe closed loop paths (such as circles) which would be induced by the trepanning optics alone. For example, a linear oscillatory motion (e.g. back and forth movements perpendicular or otherwise transverse to the weld seam) coupled with a linear motion along the interface to be welded could result in generally sinusoidal or triangular-wave-like focus point motion. The laser welding apparatus may further be a hybrid welding apparatus, such as described further herein.

Conditioning of the expanded laser beam may further include modifying the transverse electric field distribution, for example to obtain a desired focus point shape. The focus point may be circular, if desired. The apparatus may further comprise a turning mirror, for example to facilitate the welding of stiffeners to skin sheet.

Embodiments of the present invention use rotating optics to provide circular beam manipulation for high power fiber-delivered laser radiation, enabling laser stir welding. In particular, rotating optics can be used for deep keyhole welding. The vapor cavity formed at high energy densities is oscillated using the rotating optics. Advantages of oscillatory motion of the keyhole may include greater pool stability such as a self-healing keyhole, ability to accommodate larger gaps between metal components, and a wider shear plane for lap welds.

Examples of the present invention can also be used in laser cutting, laser marking, laser scribing, laser drilling, laser surface treatment processes and the like. For example, an apparatus for laser drilling may include a beam expander, a beam conditioner modifying the expanded beam so that a focus point obtained from the expanded beam describes a circular, elliptical, other closed loop, or other path. The path of the focus point can be used to cut out a hole in a metal sheet, the outer periphery of the hole being correlated with the shape of the path of the focus point. Similarly, a surface can be marked by a laser beam describing a superimposition of linear and oscillatory motion.

The invention is not restricted to the illustrative examples described above. Examples are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims.

Patents, patent applications, or publications mentioned in this specification are incorporated herein by reference to the same extent as if each individual document was specifically and individually indicated to be incorporated by reference. In particular, U.S. application Ser. Nos. 10/821,734 and 10/155,688 (and corresponding U.S. Pat. No. 6,740,845), and U.S. Prov. App. 60/675,607 are incorporated herein in by reference their entirety.

Having described our invention, we claim:

1. A method of forming a laser weld between metal components along an interface between the metal components, the method comprising:
providing a laser beam;
expanding the laser beam to provide an expanded laser beam;
conditioning the expanded laser beam; and
focusing the expanded laser beam to a focus point proximate to the interface so as to form the laser weld between the metal components,
wherein conditioning the expanded laser beam includes at moving an optical element within the expanded laser beam so as to generate an oscillatory motion of the focus point.

2. The method of claim 1, further comprising moving the focus point along a direction substantially parallel to the interface so as to extend the laser weld along the interface.

3. The method of claim 1, wherein the focus point has an optical intensity such that in the vicinity of the focus point, metal from each of the metal components melts and vaporizes to produce a keyhole in a pool of molten metal.

4. The method of claim 1, wherein the oscillatory motion of the focus point is substantially circular or elliptical.

5. The method of claim 1, wherein moving the optical element comprises rotating the optical element.

6. The method of claim 1, wherein the optical element is a lens or prism.

7. The method of claim 1, wherein conditioning the expanded laser beam includes rotating a pair of spaced apart wedge elements so as to impart a substantially circular or elliptical motion to the focus point.

8. The method of claim 1, further comprising collimating the expanded laser beam, the optical element being located within a substantially parallel portion of the expanded laser beam.

9. The method of claim 1, wherein the laser weld is a lap-penetration weld, a butt weld, or a lap-fillet weld.

10. The method of claim 1, wherein the metal components each comprise an aluminum alloy.

11. The method of claim 1, wherein the focus point oscillates at a frequency between approximately 5 Hz and approximately 120 Hz.

12. The method of claim 2, wherein the focus point moves along the interface at a rate of about 5 to about 400 inches per minute.

13. The method of claim 1, wherein the laser weld is over about 0.1 to about 0.25 inch wide.

14. The method of claim 1, wherein the oscillatory motion of the focus point is a circular motion, an elliptical motion, a spiral motion, linear motion, or some combination thereof.

15. The method of claim 1, further comprising moving the focus point along a direction substantially parallel to the metal interface so as to extend the laser weld along the interface, and
moving an arc welding torch along the direction substantially parallel to the metal interface, the arc welding torch moving ahead of or behind the focus point.

16. A method of forming a laser weld along an interface, the method comprising:
providing a laser beam;
expanding and collimating the laser beam to provide an expanded laser beam;
conditioning the expanded laser beam; and
focusing the expanded laser beam to a focus point proximate to the interface so as to form the laser weld,
wherein conditioning the expanded laser beam includes moving at least one optical element within the expanded laser beam so as to generate an oscillatory motion of the focus point.

17. The method of claim 16, wherein conditioning the expanded laser beam includes rotating a pair of spaced apart wedge elements within the expanded laser beam.

18. A laser welding apparatus for forming a laser weld along an interface between metal components, the apparatus comprising:
a source of laser radiation;
a beam conditioner, receiving the laser radiation, the beam conditioner including an optical element that is rotatable; and
a focusing element, receiving the laser radiation from the beam conditioner,
wherein the laser radiation is focused by the focusing element to a focus point, the focus point describing a substantially circular or elliptical path on rotation of the optical element,
the focus point having an optical intensity such that in the vicinity of the focus point, metal from the metal components melts and vaporizes to produce a keyhole in a pool of molten metal.

19. The laser welding apparatus of claim 18, wherein the optical element is a wedge element.

20. The laser welding apparatus of claim 18, wherein apparatus further comprises a beam translator for imparting a linear motion of the focus point substantially parallel to the interface.
